(19) United States
(12) Patent Application Publication
(10) Pub. No.: US 2008/0080766 A1
(43) Pub. Date: Apr. 3, 2008

(54) Apparatus and Method for Analyzing Skin Using L*a*b* Colorspace

(76) Inventors: Gregory Payonk, Flanders, NJ (US); Nikiforos Kollias, Skillman, NJ (US); Dick Jackson, Victoria (CA)

Correspondence Address: MCCARTER & ENGLISH, LLP, FOUR GATEWAY CENTER, 100 MULBERRY STREET, NEWARK, NJ, 07102, US

(21) Appl. No.: 11/863,333

(22) Filed: Sep. 28, 2007

Related U.S. Application Data
(60) Provisional application No. 60/848,768, filed on Oct. 2, 2006.

(51) Int. Cl. G06K 9/00

(52) U.S. Cl. 382/167

(57) ABSTRACT

An imaging system and method has digital image capture and analysis capability. The digital images may be taken in a variety of illumination conditions, with the skin response indicating skin condition. The digital images may be converted from RGB format to L*a*b* format and analyzed quantitatively to assess color and brightness. The color/brightness information from the digital images may be used to assess skin condition and changes thereof, as well as selecting cosmetics provided in a range of colors. The color information gleaned from the digital images of a population may be utilized to identify a palette of colors for cosmetics or to aid in conducting clinical studies.

### CROSS-REFERENCE TO RELATED APPLICATIONS

This application claims the benefit of U.S. Provisional Patent Application Ser. No. 60/848,768 filed Oct. 2, 2006, the disclosure of which is incorporated herein by reference in its entirety.

### FIELD OF THE INVENTION

The present invention relates to digital imaging systems and methods for analyzing a person's skin, and more particularly, to a system and method for performing quantitative analysis of skin color using digital images thereof.

### BACKGROUND OF THE INVENTION

Colorimeters and spectrophotometers have been used to measure the color of objects by performing “point” or “spot” measurements on small (e.g., 2-10 mm²) areas of the object. For example, U.S. Pat. No. 5,945,112 discloses a method for providing a cosmetics user with a customized facial foundation by analyzing small areas of the user's skin with a spectrophotometer/colorimeter to obtain coloration values in L*, a* and b* units. Spot measurements are appropriate for small objects and/or objects whose color does not vary across the surface thereof, but multiple colorimeter/spectrophotometer measurements would be required for measuring the color(s) of a large area of the skin, which may vary in color from point to point. Colorimeters and spectrophotometers are specialized instruments which typically require the application of the instrument to the surface of the skin.

Aside from instruments for ascertaining skin color, various imaging systems have been proposed that photographically capture images of a person for analysis of the skin, such as those systems disclosed in applicants' co-pending U.S. patent application Ser. No. 10/978,284 entitled “Apparatus for and Method of Taking and Viewing Images of the Skin” which was published as United States Patent Application Publication No. US 2005/0195316 A1 (“U.S. Publication No. 2005/0195316”) and application Ser. No. 11/169,813 entitled “Skin Imaging System with Probe”, which was published as United States Application Publication No. US 2006/0092315 A1 (“U.S. Publication No. 2006/0092315”), which are incorporated by reference herein. The foregoing applications disclose the use of digital photography to obtain skin images in red, green, blue (RGB) format; It should be understood that there are other acquired formats other than RGB, such as Raw or YC-tiff to which the present invention would be equally applicable.

RGB colorspace has limitations for analyzing images because the brightness of the pixels is not represented independently of color. RGB colorspace is non-linear and unit variations are not matched to human perception, such that changes of one unit in R, G, or B values are sometimes not perceptible to human vision. For these reasons, images in RGB colorspace, such as those obtained by RGB cameras, are not optimal in certain instances for performing quantitative analysis of skin color, e.g., as would be desirable in the formulation, selection and matching of cosmetics to the skin color of a cosmetics user or measuring skin color response or changes in skin color over time.

### SUMMARY OF THE INVENTION

The problems and disadvantages associated with conventional apparatus and methods used in skin color analysis and related processes, such as cosmetic design and selection are overcome by the present invention, which converts the RGB colorspace pixel values defining an image of the user's skin into L*a*b* colorspace data to achieve an alternative quantification and characterization of skin color, which can be used for a variety of purposes. For example, embodiments of the present invention may be used to select cosmetics for an individual or design a color palette of cosmetics for a population of users. Embodiments of the invention may be used to ascertain skin condition and track changes in skin condition. Other aspects, features and advantages of the present invention will be apparent from the detailed description of the invention that follows.

### BRIEF DESCRIPTION OF THE DRAWINGS

FIG. 1 is a diagrammatic view of a digital imaging system in accordance with the present invention.

FIG. 2 is a diagrammatic view of an image of a subject in a specific color plane, e.g., the green plane of a digital image.

FIG. 3 is a diagrammatic view of the plotting of a fragment of a digital image in RGB and in L*a*b* colorspaces.

FIG. 4 is a diagrammatic view of the comparison of digital images taken at different times, the comparison of a digital image to a cosmetic palette and the development of a cosmetic palette from population imaging.

FIG. 5 is a flowchart of a process in accordance with the present invention.

### DETAILED DESCRIPTION OF THE INVENTION

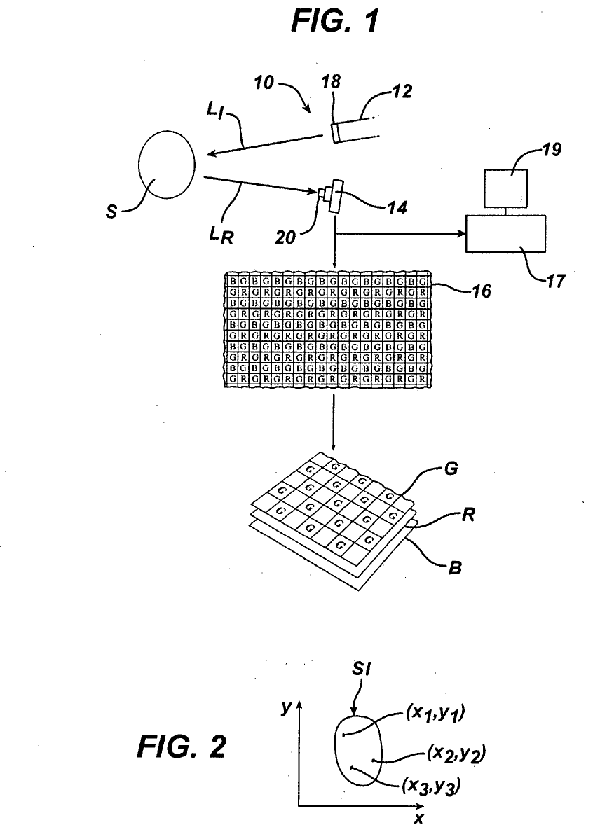

FIG. 1 diagrammatically illustrates a digital imaging apparatus 10 having a source of illuminating light 12 (e.g., a photo flash) and a digital camera 14. An image of the subject S is recorded by the camera 14 in the form of a matrix 16 of red, green and blue pixel values (RGB format). The matrix 16 of values is typically produced by a Bayer-filtered close-coupled display CCD and the information is stored in a memory device, such as random access memory (RAM) of computer 17 or on a flash memory card. The RGB data can be separated into channels or planes, R, G and B, one plane for each color. Various frequencies of illuminating light L_{I} disposed at varying positions relative to the subject S may be used to capture digital images of the subject S in order to capture different information about the skin of the subject. Filters 18, 20 may be employed on the light 12 and the camera 14, respectively, to control the light frequency/polarity of light L_{I} which is projected on the subject S, as well as controlling the light L_{R} (reflected or emitted from the subject S), which is admitted into the camera 14. Imaging of this type is described at length in U.S. Publication No. 2005/0195316 and U.S. Publication No. 2006/0092315, both of which are incorporated by reference herein. The foregoing applications disclose various correlations between skin condition and the images produced by various photographic parameters, i.e., specific combinations of illuminating light L_{I}, filters 18, 20, etc. The skin response to different illuminating frequencies, angles, polarity etc. can reveal information about skin condition and this evidence of skin condition can be recorded and recalled in digital images for purposes of analysis.

Since the images recorded are in digital form, i.e., in numerical pixel intensity values, the images lend themselves to quantitative analysis, such as by computer 17. For example, instead of just noting that the cheek of a subject whose image is taken at time T₁ is more or less red in color in an image of the person taken at time T₂, as discerned by a skilled human observer, the values of the intensity of the red pixels in the specific area of the cheek at times T₁ and T₂ may be quantitatively compared. Digital image quantification can be used to discern average values for the skin in specified regions, e.g., by summing the values of pixels in the specific region of interest and then dividing by the number of pixels. In this manner, a whole area of skin, e.g., of the face, may be characterized quantitatively. Various other quantified analyses may be conducted, e.g., the imaged area of skin may be tested for standard deviation in pixel intensity.

FIG. 2 shows a diagrammatic view of the image of a subject SI that resides in one color plane or channel of an RGB image, e.g., the color Green. The image is formed by a matrix of pixels extending in an X-Y plane, each pixel having an x,y location. The location of three sample pixels is shown, viz., at (x1, y1), (x2, y2) and (x3, y3).

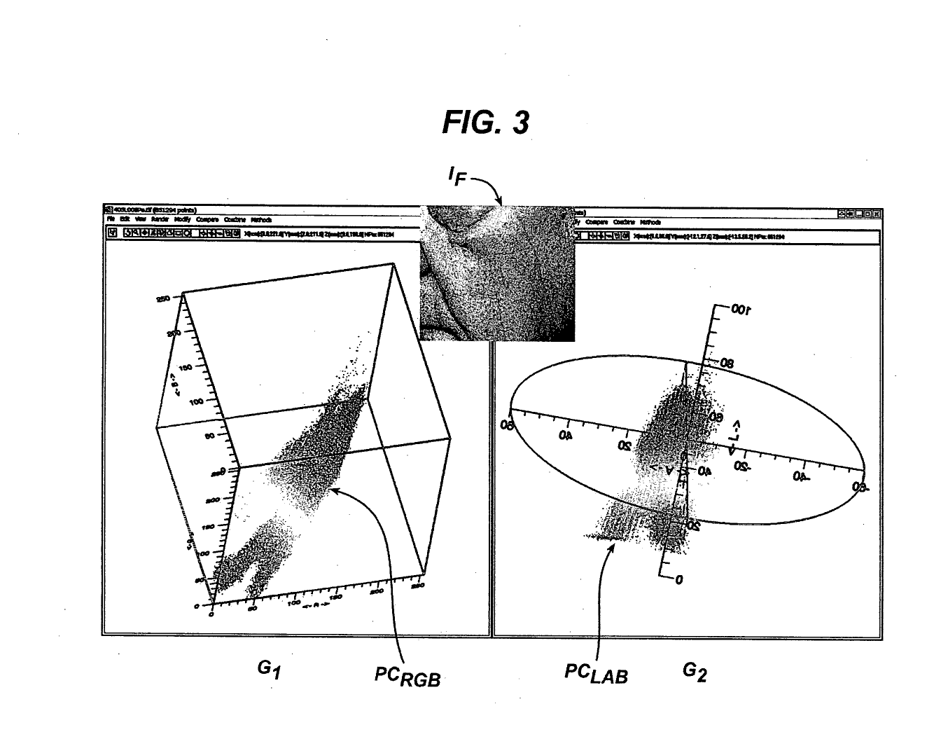

FIG. 3 shows two, three-dimensional graphs G₁, and G₂ resulting from plotting each pixel of an image fragment I_{F} in RGB colorspace and L*a*b* colorspace. For all pixels in an image SI, e.g., from a digital photograph, the associated pixel intensity is determined by the photo-response of a photosensitive element, e.g., a voltage induced in a capacitor element in a CCD array. This voltage level can be digitized and stored as a numerical value. When photointensity of each RGB triple of a digital image is plotted in RGB space, a three-dimensional point cloud PC RGB results. This plot and the underlying intensity data may be used to quantitatively assess various states and parameters of the skin of the subject S whose image was captured in the image SI.

Digital images composed of a plurality of pixel intensity values in the red, green, and blue (RGB) planes may be subjected to quantitative analysis to serve a variety of objectives. The present invention recognizes that the quantitative analysis of digital images of the skin can, in certain instances, be improved by first converting RGB image data to a L*a*b* format. In the L*a*b* colorspace, the L* component represents lightness or brightness (i.e., light to dark, or white to black), and is separate from and independent of the a* and b* color components. The a* component is a measure of the amount of redness and greenness in an image (i.e., a value on the red-green color continuum). The b* component is a measure of the amount of yellowness and blueness in an image (i.e., a value on the yellow-blue color continuum). The L*, a* and b* components of the L*a*b* colorspace are represented by a light-dark axis, a red-green axis and a blue-yellow axis, respectively, so as to form a three-dimensional space. The color measurement of any pixel, or group of pixels, in an image may thus be represented in terms of its L*, a* and b* coordinates in the L*a*b* colorspace.

The benefits of L*a*b* colorspace include its amenability to linear computations in analyzing pixel color values and to assess changes in color independently of changes in brightness. L*a*b* colorspace is also uniform and consistent with human vision perception (i.e., psychophotometric), so that a change in one unit of brightness or color is generally perceptible throughout the L*a*b* colorspace. The present invention recognizes the utility of converting images acquired in RGB colorspace such as from digital cameras, scanners, etc. into L*a*b* colorspace to make quantitative measurements of changes in color or lightness, which might be related to product efficacy or functioning, or more simply to follow the change in a subject's (skin) color over time.

The conversion of RGB image data to L*a*b* colorspace is well defined and known to one of normal skill in the art. Exemplary calculations for doing the conversion can be found in Charles Poynton, A Technical Introduction to Digital Video (J. Wiley & Sons) Chapter 7 “Color Science”.

FIG. 3 illustrates the conversion of the red, green and blue intensity values (shown plotted in graph G₁) of an image fragment I_{F} into L*a*b* coordinates. After the conversion, the image data expressed in L*a*b* coordinates forms a point cloud PC_{LAB}, which may be divided into sub-planes or channels and plotted in three-dimensional graphs, expressing the measure of each parameter (L*, a* and b*) for each pixel in the image fragment I_{F} or the L*a*b* values may be subjected to numerical processing or analysis.

The foregoing conversion from RGB to L*a*b* is preferably conducted in a computer, such as computer 17 of the imaging apparatus 10. In one implementation of the programmatic conversion, the digital, RGB image data 16 is expressed as a byte-type memory array that may be called “rgb.” A procedure for executing the conversion process in accordance with the above-referenced method is defined and may be called “RGBtoLAB,”. RGBtoLAB operates on the RGB image data 16 to return a new, floating-type memory array which may be called “lab.” The mathematical function would appear as: lab=RGBtoLAB(rgb).

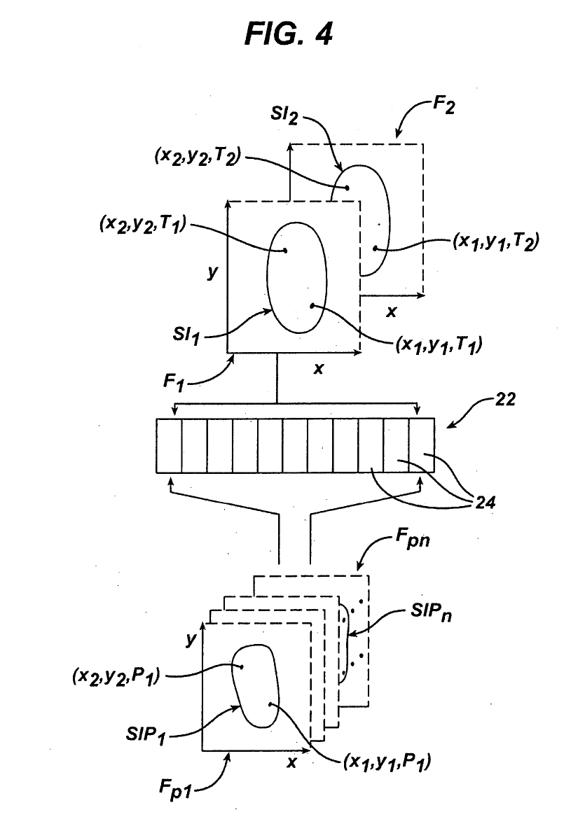

FIG. 4 shows a pair of subject images SI₁ and SI₂, which are taken at times T₁ and T₂, respectively, e.g., representing two digital photograph frames F₁ and F₂. As described above, the RGB pixel data associated with any and all locations, e.g., (x₁, y₁, T₁) can be converted to L*a*b* format. As described in U.S. Publications 2005/0195316 and 2006/0092315, the skin's response to various forms of illumination light, illumination orientations and polarization can yield information concerning the skin's condition in various respects. Because the image data resulting from digital imaging is quantified, both in RGB and in L*a*b* formats, the various responses of the skin, when subjected to various forms of imaging, can be quantified and analyzed quantitatively. In certain instances, quantitative analysis of digital image data expressed in specific planes from L*a*b* colorspace affords an advantage over similar analysis of RGB color channels, e.g., because the intensity or brightness of a pixel is separate from color. This characteristic of L*a*b* colorspace allows the consideration and measurement of color response independent of brightness. For example, the a* channel is ideal for identifying and/or counting the number of pixels in selected shades of red in an image when the red response is indicative of skin condition. For example, the a* channel may be used to identify and quantify redness attributable either to hemoglobin (as visualized in cross polarized illumination) or porphyrin (from blue fluorescence illumination). More generally then, if a skin response in a specific shade of red (or any other color) is indicative of skin condition in some respect, then a digital image expressed in L*a*b* coordinates may be used to identify and quantify that specific color response. Differences in redness between images can be quantified by simple subtraction.

Another example of using L*a*b* colorspace for analysis is the use of the L* channel data of an image obtained by illumination in white light (and/or using cross or parallel polarizing filters on the illuminating light and/or the camera.) to assess overall skin lightness/darkness. The L* channel image data can also be utilized to identify tiny, white areas in an image representing the response of clogged pores to blue fluorescence illumination. In addition to the identification of specific responsive color shades in digital images, the intensity of response is also a useful measure for assessing skin condition. Given a specific color shade of a pixel as specified by its associated coordinate on the a*, b* plane, the L* value of that pixel can be used to determine the intensity of the specific color of that pixel.

Since color shade may be defined in the L*a*b* colorspace independently of intensity, the measurement of the color shade of a person's skin may be ascertained from her/his digital image translated to L*a*b* coordinates, independent of illumination intensity. The color of the skin may be determined by sampling and/or by averaging the color shade of pixels corresponding to the face. Accordingly, an “average color” for the person may be determined by calculating it. Alternatively, the average color may be restricted to a specific region or regions of skin, e.g., the cheek, forehead, nose and chin. In either case, the color shade of the skin ascertained by image analysis can be utilized to compare it to the color shades of a palette 22 of available cosmetics, such as foundation, in a plurality of color shades 24. The cosmetic color shades 24 may be analyzed and quantified in terms of their color as expressed in L*a*b* colorspace. In this manner, the “average color” of the individual may be quantitatively compared to the available colors in the palette 22 and the closest individual shade 24 identified. In addition to color matching, the individuals' L*a*b* image data may be compared to the available colors in the palette 22 to lighten or darken the skin by a selected, controlled amount.

Further with respect to a cosmetic palette 22, the present invention may be utilized to ascertain the color shades 24 selected for and presented in the palette 24. More particularly, as shown at the bottom of FIG. 4, a plurality of images SIP₁ to SIPₙ of different persons may be taken. Each image of this group of images may be analyzed and quantified in terms of the color or average color of the person appearing in the image. Optimally, a broad base of subject images will be obtained representing the entire spectrum of skin colors for all people, including all races and nationalities. The image data, e.g., expressed in L*a*b* coordinates can then be sorted by L*, a* and b* values in ascending or descending order, yielding a spectrum of color shade and brightness values from which endpoints on these spectrums can be selected and the spectrum divided numerically into a desired number of shade/brightness gradations. The numerical division will result in shade/brightness values (L*a*b* coordinates) that can then serve as the target colors for the color shades 24 in a palette of cosmetics 22. This process differs from known methods wherein the color shades 24 are determined by percent composition of various pigments in the cosmetic, in that the color shades 24 identified in the present invention are evenly distributed over a range of real world values of skin color (because the L*a*b* colorspace is linear) as determined experimentally. In the instance of varying cosmetic color by composition, the color shades are developed independently of observed shades/brightness of users' skin and therefore are “unnatural” and not distributed evenly in the spectrum of actual skin tones. Once the target colors for the colors shades 24 are determined, the composition of the cosmetic can then be adjusted until the various target colors are realized.

As noted above, FIG. 4 shows that multiple images may be taken of a person over time to assess and quantify changes in their responses to digital imaging that are indicative of changes in their skin condition. Since the conversion to L*a*b* is available to identify and quantify color response, the comparison of different values in color/intensity response between different sessions of imaging to discern changes and trends is enhanced over that available in RGB analysis alone. Construction of a spherical 3D coordinate plot of L*a*b* channels reveals the distribution of the pixels making up the image being analyzed. Changes in the colorspace distribution can be used to determine improvements in skin redness, sallowness, pigmentation, tanning, tone evenness, etc., for an individual, treatment group or population.

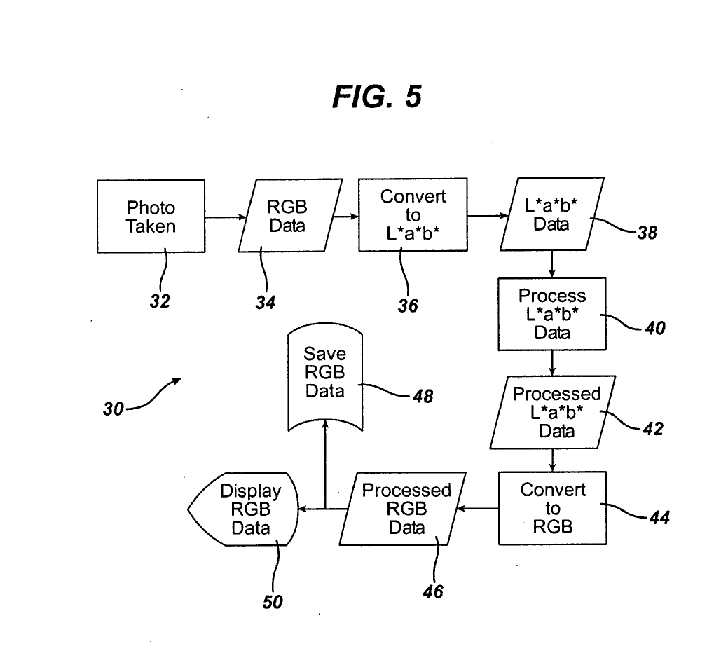

FIG. 5 illustrates a process 30 in accordance with the present invention for utilizing L*a*b* colorspace conversion to aid in visualizing and analyzing skin condition. A digital photograph is taken 32, resulting in RGB image data 34. The RGB data is converted 36 to L*a*b* data 38. This L*a*b* data 38 is then processed 40, e.g., by changing the color or brightness of the selected pixels in the image, to generate processed L*a*b* data 42 (The modified array may be called “processed_lab”.). In one instance, identifying pixels responding in a specific color shade may be utilized to display that subset of pixels in a manner which highlights their presence in an image, e.g., displaying all qualifying pixels at relatively greater intensity, e.g., by numerically augmenting their associated L* values. The processed L*a*b* data 42 may then be converted 44 to RGB data resulting in processed RGB data 46 (a new byte-type memory array for expressing an image in RGB colorspace). This RGB data 46 may then be saved 48 and displayed 50, e.g., on a computer monitor.

The present invention recognizes that converting images acquired from devices such as digital cameras, scanners, etc., that necessarily exist in RGB colorspace into L*a*b* colorspace, provides certain advantages. For example, (1) in L*a*b* colorspace, pixel brightness is translated to its own channel (L*) and thus does not confound color measurements, (2) computations involving pixel values in the L*a*b* colorspace channels are linear unlike RGB colorspace which is non-linear, (3) changes in colors can be assessed without influence (within reason) of changes in brightness (or illumination) on acquisition, (4) a one unit change in L*, a* or b* is known to be perceptible by humans whereas a 1 unit change in R, G or B value may or may not be perceptible depending upon whether the change is from 50 to 51 or 245 to 246 for example, (5) entire digital images, or sub-regions within, may be conveniently represented as an L*a*b* triple unlike chromameter measurements which are obtained from a small spot or point area only and require multiple measurements to be made to characterize larger areas. L*a*b* values representing digital images can be stored in a database and subjected to data mining techniques, e.g., (i) to select subjects from a population that have a characteristic or characteristics of interest; (ii) to monitor subjects from a population that have desired characteristics, (iii) to monitor subjects in clinical trials for deviations from norms, or (iv) to analyze the data from subject in clinical trials to select positive or negative (adverse) responders.

It should be understood that the embodiment described herein is merely exemplary, and that a person skilled in the art may make many variations and modifications without departing from the spirit and scope of the invention. For instance, while the present has been explained in terms of facial imaging, the present invention could also be used to image and analyze other parts of the body. While the invention has been explained in terms of converting RGB data to L*a*b*, other forms of acquired data, such as Raw or YC-tiff could be converted in accordance with the teachings of the present invention. All such variations and modifications are intended to be included within the scope of the invention.

We claim:

1. A method for analyzing skin color, comprising the steps of:
(A) capturing a digital image of skin using a first colorspace;
(B) storing the digital image as data;
(C) converting the digital image data to L*a*b* colorspace data;
(D) quantitatively analyzing the L*a*b* colorspace data.

2. The method of claim 1, wherein step (D) includes ascertaining the average color of a face from the a*b* values of the L*a*b* colorspace data.

3. The method of claim 2, wherein the average color is used to select a cosmetic from a cosmetic palette.

4. The method of claim 3, wherein the cosmetic is foundation.

5. The method of claim 3, wherein the cosmetic is selected to achieve a specific re-coloring goal based upon the average color.

6. The method of claim 2, wherein the average color is used as a target color for formulating a cosmetic.

7. The method of claim 1, wherein said step (D) includes ascertaining the intensity of the red response of skin by isolating the a* values of the L*a*b* colorspace data, wherein said step (A) of capturing is conducted in cross-polarized light, and the red response is interpreted as an indicator of hemoglobin.

8. The method of claim 1, wherein step (D) includes ascertaining the intensity of the green response of skin by isolating the a* values of the L*a*b* colorspace data, wherein said step (A) of capturing is conducted in blue light, and the green response is interpreted as an indicator of porphyrin.

9. The method of claim 1, wherein said step (D) includes ascertaining the intensity of brightness response of skin by isolating the L* values of the L*a*b* colorspace data and wherein said step (A) of capturing is conducted in polarized light.

10. The method of claim 1, wherein said step (D) includes ascertaining the intensity of the brightness response of skin by isolating the L* values of the L*a*b* colorspace data, wherein said step (A) of capturing is conducted in blue light, and the brightness response is interpreted as an indicator of clogged pores.

11. The method of claim 1, further comprising the steps of repeating steps (A) through (C) a plurality of times for different persons in a given population.

12. The method of claim 11, wherein the L*a*b* colorspace data for the population define a range of color/brightness values, which is divided by a selected number N to yield a finite number of cosmetic target colors distributed approximately evenly over the range.

13. The method of claim 12, further comprising the step of preparing a plurality of cosmetic compositions having colors approximating the target colors.

14. The method of claim 11, further comprising the step of storing the L*a*b* colorspace data for the population and the step of searching the data for instances of satisfying a selected criteria.

15. The method of claim 14, wherein at least one of the digital image data and the L*a*b* colorspace data includes an identifier of the subject of imaging and a flag indicating participation, if applicable, in a clinical study and the criteria is participation in the clinical study.

16. The method of claim 14, further comprising the step of analyzing the L*a*b* colorspace data for the population to identify a normative value range and wherein the criteria during searching is deviation from the normative value range.

17. The method of claim 16, wherein the deviation is indicative of response to treatment of the skin.

18. A method for analyzing the skin color of a person, comprising the steps of:
(A) capturing a first digital image of the skin of the person using a first colorspace at time t1;
(B) storing the digital image as data;
(C) capturing a second digital image of the skin of the person using the first colorspace at time t2;
(D) converting the first and second digital image data to L*a*b* colorspace data;
(E) quantitatively comparing the L*a*b* colorspace data for the first and second images to ascertain color/brightness differences that are present in the first and second images.

19. The method of claim 18, wherein the comparison conducted in said step (E) includes comparison of at least one region of the skin which is substantially the same in both the first and the second images.

20. The method of claim of claim 19, wherein the comparison includes a plurality of regions of the skin which are substantially the same in the first and second images.

21. The method of claim 20, wherein the regions compared are of the face of the person and the first colorspace is RGB, and further including the step of comparing the mean color/brightness values of the first and second images, as ascertained from the respective L*a*b* colorspace data corresponding thereto.
